(19) United States
(12) Patent Application Publication
(10) Pub. No.: US 2022/0092668 A1
(43) Pub. Date: Mar. 24, 2022

(54) SERVICES GROUPINGS FOR STRATEGIC CONSUMPTION

(71) Applicant: International Business Machines Corporation, Armonk, NY (US)

(72) Inventors: Cindy Han Lu, San Jose, CA (US); Megan Kostick, Edmonds, WA (US); Michael Brewer, Austin, TX (US); Thai Quoc Tran, San Jose, CA (US)

(21) Appl. No.: 17/026,392

(22) Filed: Sep. 21, 2020

(51) Int. Cl. G06Q 30/06; G06Q 10/06; G06Q 30/02; G06N 20/00; G06N 5/04

(52) U.S. Cl. CPC G06Q 30/0631; G06Q 10/0639; G06Q 30/0204; G06N 5/04; G06Q 30/0282; G06N 20/00; G06Q 30/0625

(57) ABSTRACT

Service deployments of multiple services are grouped together according to common usage history. Services are proposed for a user account where one service of a services group is deployed and another service of the services group is new, or not deployed by the user account. Usage factors specific to a user account a weighted for ranking recommendation of certain services within service groups have at least one deployed service and at least one new service.

### BACKGROUND

The present invention relates generally to the field of cloud computing, and more particularly to grouping cloud services.

Cloud computing is the on-demand availability of computer system resources, particularly data storage (cloud storage) and computing power, without direct active management by the user. The term cloud computing is used to describe data centers available to many users over the Internet. Large clouds often have functions distributed over multiple locations from central servers. If the connection to the user is relatively close, it may be designated as an edge server. Clouds may be limited to a single company or be available to many companies. Cloud computing relies on sharing of resources to achieve coherence and economies of scale for all users.

A cloud can contain a service catalog. A cloud service catalog contains a set of cloud services that an end user can request and can usually be obtained through a web self-service portal. A cloud service catalog acts as the ordering portal for cloud end users such as companies and organizations. The cloud service catalog typically including pricing, service-level commitments, and the terms and conditions for service provisioning.

### SUMMARY

According to an aspect of the present invention, there is a method, computer program product and/or system for presenting services based on a history of usage data that performs the following operations (not necessarily in the following order): (i) recording a history of service deployments including performance metrics and a usage history of services deployed for a set of services accounts; (ii) analyzing the history of service deployments for identification of service groups; (iii) identifying existing service deployments of a first services account; (iv) ranking a set of service groups according to usage factor values for the first services account, each service group including a plurality of services deployed together according to the usage history of service deployed; (v) identifying among the set of service groups a set of candidate service groups, the candidate service groups including an existing service deployment of the first service account and a new service not deployed by the first service account; and (vi) presenting a services catalog for the first services account including a candidate service group of the set of candidate service groups.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a block diagram showing a machine logic (for example, software) portion of the first embodiment system; and

FIG. 6 is a system diagram showing a first embodiment method performed, at least in part, by the first embodiment system.

### DETAILED DESCRIPTION

Today, when we go to a cloud service catalog, it is laid out in the same way for everyone regardless of the task being performed or purpose of using the cloud service catalog. The catalog may be broken down, for example, into categories such as security, storage, network, a question-answering computer system, internet of things (IoT), etc. The catalog may include a search field or offer sorting options including alphabetical order and most popular services. The cloud service catalog does not provide guidance on how to do something, what services are related to each other, or which services are best used together. For example, if a user wants to build a website from scratch, end to end, the user needs to set up the full-service stack, which may be a daunting task. By learning what other users are doing, what services are best used together, and what services are dependent on each other, the services catalog guides the user in the way the catalog is presented.

Some embodiments of the present invention are directed to service deployments of multiple services are grouped together according to common usage history. Services are proposed for a user account where one service of a services group is deployed and another service of the services group is new, or not deployed by the user account. Usage factors specific to a user account a weighted for ranking recommendation of certain services within service groups have at least one deployed service and at least one new service. This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

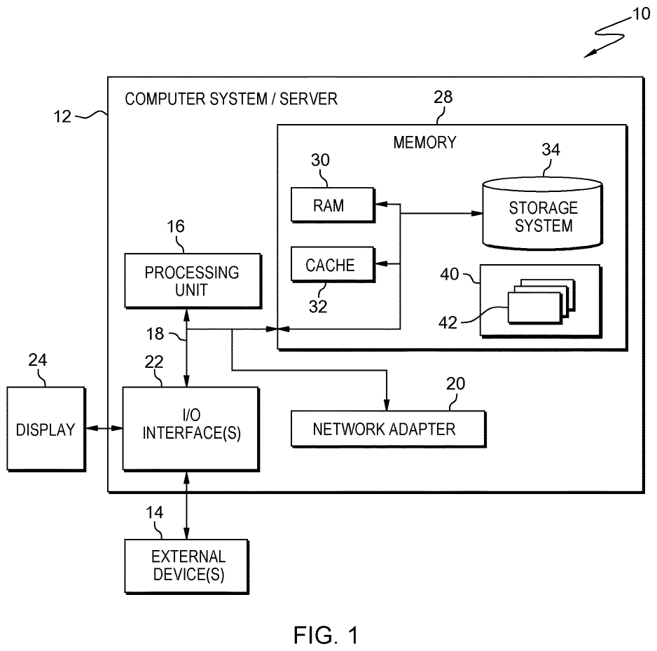

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

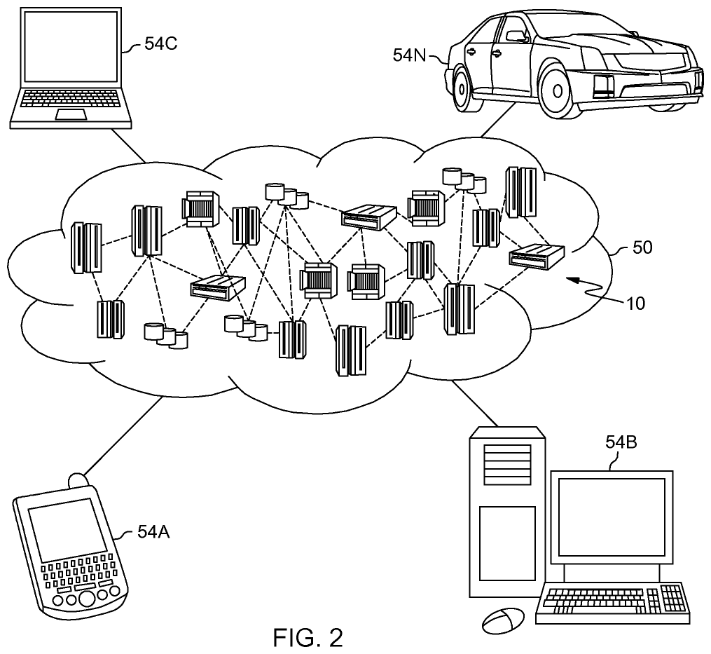

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

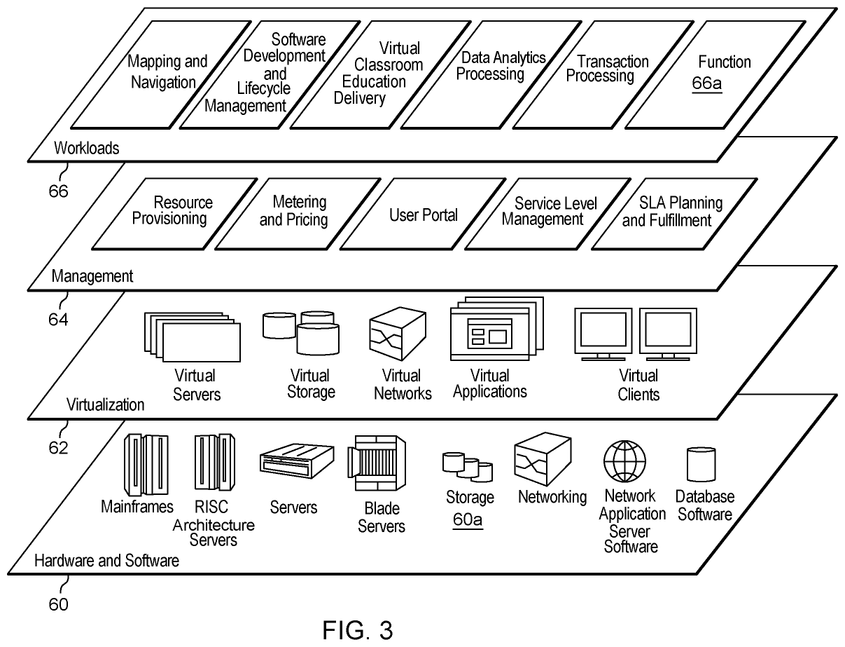

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. EXAMPLE EMBODIMENT

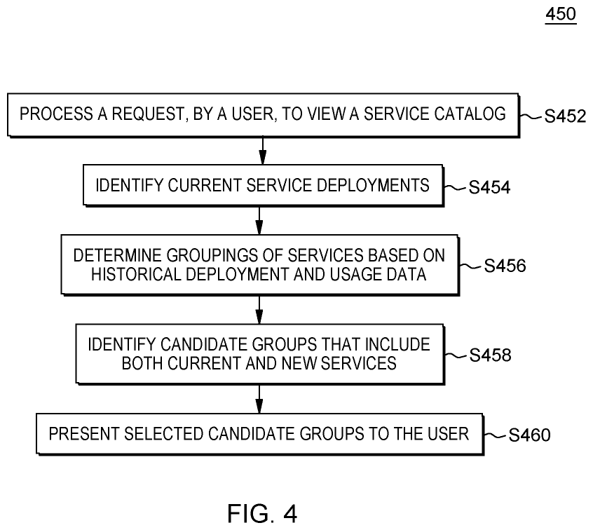

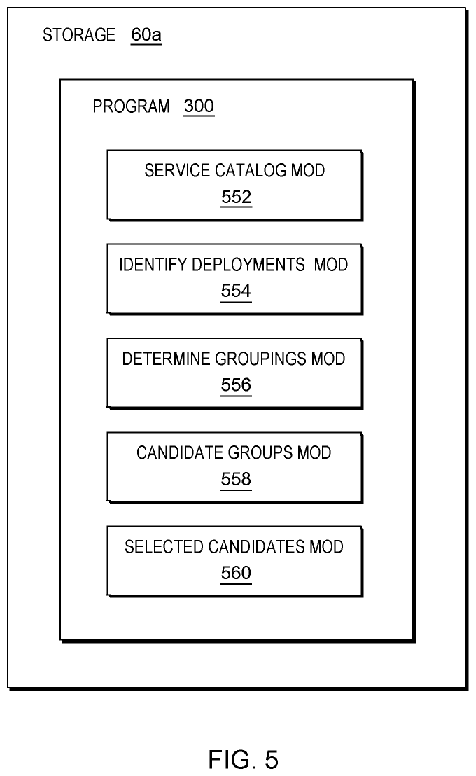

FIG. 4 shows flowchart 450 depicts a method according to the present invention. FIG. 5 shows program 300 within storage 60a for performing at least some of the method operations of flowchart 450. This method and associated software will now be discussed, over the course of the following paragraphs, with extensive reference to FIG. 4 (for the method operation blocks) and FIG. 5 (for the software blocks). One physical location where program 300 of FIG. 5 may be stored is in storage block 60a (see FIG. 3). FIGS. 1-3 may also be discussed herein.

Processing begins at operation S452, where service catalog mod 552 processes a request, by a user, to view a service catalog. In this example a user request is received from a user device associated with a current customer communicating over cloud computing environment 50. The requested service catalog presents services related to a one or more service models provided by a service provider. Processing the request includes steps that support the objective of returning to the user a service catalog having commonly associated services presented in a grouped manner that allows the user to quickly identify additional services that may improve and/or further support current services deployed by the current customer. Steps that support this objective may include: (i) identifying an account through which the user deploys services; (ii) determining how long the account has been active; (iii) identifying the type of account being used; (iv) for multiple accounts associated with the user, identify the account of interest; (v) deployment limitations unique to the user's account; (vi) geographic region of the requesting user; (vii) geographic region of the enterprise associated with the account; and/or (viii) user's computing system health.

Processing proceeds to operation S454, where identify deployments mod 554 identifies current service deployments. Based on information gathered during the processing step above, the identify deployments mod retrieves a record of current service deployments associated with the account of the requesting user. In this example, the current services are grouped according to a pre-defined scheme in support of identifying additional services in the steps that follow. The pre-defined scheme may also be referred to as a clustering algorithm with reference to clusters instead of groups. Alternatively, each current service stands alone for later reference. Alternatively, current services are identified by recency of deployment.

Processing proceeds to operation S456, where determine groupings mod 556 determines groupings of services based on historical deployment and usage data. The notion of grouping of services recognizes that many services are best utilized in conjunction with other services. In this example, determining groupings is based on general use metrics collected over time across a customer base. Monitoring usage of services including quality of service parameters supports the determination of groupings. In some embodiments, version-specific service deployments are identified and monitored for performance. In that way, groupings of services are based on actual deployments groups of version-specific pairings are determined to be valid and successful.

Monitoring activities for collecting deployment and usage data may include but are not limited to: (i) provision time; (ii) uptime; (iii) downtime; (iv) fail-over rates; (v) fewest number of clicks; (vi) network latency; and (vii) user experience via feedback. In some embodiments, historic records of successful deployments of services are analyzed by a trained neural network to apply a deep learning to identify service dependencies among existing service deployments. Alternatively, successful deployment history is organized into training modules for machine learning processing. The analysis draws correlations between deployed services to understand what the customer base typically deploys together in the cloud. Service pairs or service groups arising from analysis of existing deployments are defined for use in identifying candidate new services for the requesting user prior to display of the service catalog.

In some embodiments a clustering algorithm is developed according to the determined groupings of services. Clustering of services may be based on one or more of the following observed elements: (i) service dependencies; (ii) service costs; (iii) account type; (iv) customer/industry type; (v) inter-service network traffic; (vi) product network traffic; (vii) service stability; (viii) service scalability; (ix) geographic region of the user; (x) open source licenses; and/or (xi) available service versions.

Processing proceeds to operation S458, where candidate groups mod 558 identifies candidate groups that include both current and new services. In this example, the current deployments identified at step S454 are identified within grouping of services as grouped in step S456. Each grouping of services containing both a current service and a new service (not currently deployed by the requesting user or associated account) is identified as a candidate group. When all candidate groups are identified, a further filter may be applied to reduce the total number of candidate groups. In this example, the candidate groups are ranked for specific use by the account according to weighting factors including account budget and scalability of the candidate groups. Alternatively, selected candidate groups are filtered according to factors including, but not limited to: (i) stability; (ii) multi-region availability; (iii) all open source licenses; (iv) a certain type of license; (v) account budget; and/or (vi) scalability.

Processing concludes at operation S460, where selected candidate's mod 560 presents selected candidate groups to the user. In this example, selected candidate groups are the top three candidate groups according to the ranked candidate groups in view of the weighting factors. Alternatively, each candidate group identified in step S458 is selected for presentation to the user. Alternatively, a ranked display of the candidate groups is presented to the user such that current deployments are in one sub-group and new services are in another sub-group where successfully co-deployment is illustrated. While there are many ways in which a display of selected candidate groups may be implemented, the user is presented new services in view of how they are compatible with or otherwise useful with current services deployed by the user. Additional services may also be presented according to conventional service catalogs. The selected candidate groupings are established according to various factors such as long term/short term cost, stability, scalability, multi-region, all open source/certain licenses. In some embodiments of the present invention, examples are provided to illustrate how to integrate the new services of the candidate groups and where the new services may be integrated into current services.

### III. FURTHER COMMENTS AND/OR EMBODIMENTS

Some embodiments of the present invention recognize the following facts, potential problems and/or potential areas for improvement with respect to the current state of the art: (i) existing open cloud marketplace service catalogs are usually organized by category and can only be sorted and filtered by type, popularity, and/or alphabetically; (ii) the service catalogs are always static; (iii) for a new user, it is hard to determine which service will best fit your needs without doing prior research; and (iv) the service catalog is not intuitive in anyway.

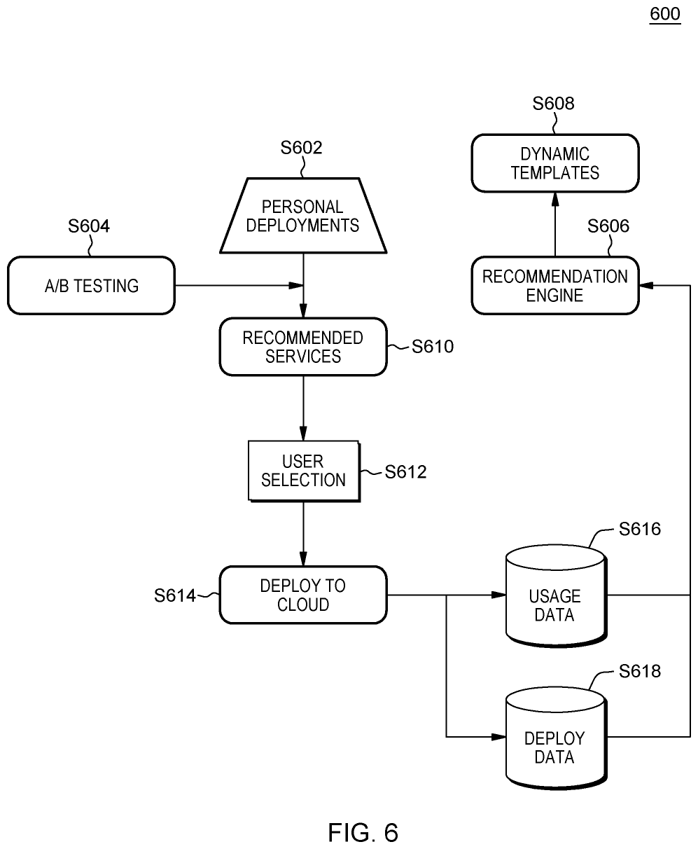

FIG. 6 shows flowchart 600 depicting a method according to embodiments of the present invention. In this method, dynamic templates are generated for service catalog views based on deployed services among a customer base. The method of flowchart 600 may be performed by software stored in storage 60a. This method will now be discussed, over the course of the following paragraphs, with extensive reference to FIG. 4.

Processing begins at step S602 where the program identifies personal deployments of a customer. The customer in question may be a new customer having no service deployments with the service provider practicing the present process. For new customers, selection of a service catalog view may be based on popular services or services deployed with another service provider.

Processing proceeds to step S604 where the program identifies results of service test groups. The service test groups allow for the service provider to test various services and how they operate together. Successful operation sets make up the results provided by the service test groups.

Processing proceeds to step S610 where the program generates a set of recommended services. The services are recommended according to successful operations in the test group and deployments or deployment history of the customer. Recommended services are new to the user, that is they are services not recorded as having been deployed by the user. The recommended services are presented to the customer for selection.

Processing proceeds to step S612 where the user selects one of the recommended services for deployment.

Processing proceeds to step S614 where the program causes the selected service to be deployed to the cloud for access by the user. When a service is deployed using the recommended services process described herein, the deployment is monitored for usage and performance.

Processing proceeds in parallel to steps S616 and S618 where the program collects data while monitoring deployment of the recommended service. Step S616 records usage data including: (i) service version; (ii) service license; (iii) service tags; (iv) dependencies; (v) cost; (vii) account type; (viii) company/industry type; (ix) interservice/product network traffic; (x) stability; and/or (xi) geographic region. Step S618 records deployment data including: (i) service ID, (ii) provision duration; (iii) service up-time; and/or (iv) latency.

Processing proceeds to step S606 where the program develops recommendations according to the collected data at steps S616 and S618 and further in view of the testing results of S604. Recommendations of groups services are recorded to a database for processing in the next step.

Processing ends at step S608 where the program creates dynamic templates for service catalogs showing various grouped services as recorded by the recommendations of step S606. Dynamic templates are stored for access upon request for a services catalog. The templates are customizable to the customer-specific need as determined when evaluating current service deployments and new user historic deployments.

Some embodiments of the present invention may include one, or more, of the following operations, features, characteristics and/or advantages: (i) solves how to reorder the SaaS (software as a service) services between A and B to satisfy all of the factors which would lead to more revenue generation; and (ii) optimizes the ranking of possibly dependent services instead of using an automatic action to “buy item X”, such as using today's known solutions such as commercially available product recommendation systems.

Some embodiments of the present invention may include one, or more, of the following operations, features, characteristics and/or advantages: (i) increases revenue through recommendation of services; (ii) improves user experience and potentially even saving costs by exposing services that are not really needed or services that can be substituted; (iii) inspires innovation by suggesting trending services; and (iv) explores new capabilities with deployed services using similar workflows.

Some embodiments of the present invention may include one, or more, of the following operations, features, characteristics and/or advantages: (i) uses deployment history to draw correlations between services to see what people normally deploy together in the cloud; (ii) has the ability to recommend higher or lower provision sets based on known load trends and averages; (iii) uses commonly associated services to display the service catalog in a uniquely grouped way, so the user finds needed services quickly and in one place; (iv) monitors services and generates a score for each service (based on various factors) in order to determine what services to do A/B testing on; and (v) provides examples of how to integrate new services if the new services can be integrated into existing services.

A method according to an embodiment of the present invention includes the following operations (not necessarily in the following order): (i) a user usually has a pretty good idea of what needs to be done and what services are required to accomplish the job. The user goes to a cloud portal and provisions all the said services above. We can think of each provision as a bulk action that results in the generation of a purchase receipt, similar to items in a cart before checking out. Using similar logic, we can use existing technologies to make recommendations of services in the future; (ii) a simple example of how such service recommendations will work consist of finding correlations among services that are usually provisioned together. Such services can be classified into the same cluster or identification group. Based on millions of provisions, we can confidently group and classify them and make recommendations for future provisioning; and (iii) additionally, we can monitor the health and metrics of services once they are provisioned and used. Based on the incoming traffic, we can clearly see the effects of it on the hardware. There currently exist monitoring solutions that will auto provision new services to accommodate the spike in traffic. When a new user attempts to provision a similar service, the system is smart enough to make recommendations on how much of that service to provision given the historical data.

Examples of some of the metrics that can be monitored according to an embodiment of the present invention includes the following operations (not necessarily in the following order): (i) provision time; (ii) uptime; (iii) downtime; (iv) fail-over rate; (v) fewest number of clicks; (vi) network latency; and (vii) user experience—feedback loop from users.

Some embodiments of the present invention may include one, or more, of the following operations, features, characteristics and/or advantages: (i) each provision generates metrics that can be monitored and tracked; (ii) assigns to each metric a weight, where the sum of all of the metric and their corresponding weight is the total score; (iii) ability to identify and make recommendations based on the classification; and (iv) utilizes the score to sort recommendations based on the metric score.

Some embodiments of the present invention may include one, or more, of the following operations, features, characteristics and/or advantages: (i) present data to the user in such a way as to maximize the chances of them provisioning related services (for example, if you provision a free and open-source content management system, you will need an open-source relational database management system database, and possibly an object storage service as well). The free and open-source content management system needs the open-source relational database management system, but not necessary the object storage; and (ii) services that are not required can then be listed in the order of their metric score and a description of features each service can provide (for example, you can later come back and provision a question/answering computer system capable of answering questions posed in natural language, it would then suggest ways to integrate the new service to your existing service(s)).

Some embodiments of the present invention may include one, or more, of the following operations, features, characteristics and/or advantages: (i) the system can permutate different combinations of services that are within a range of an acceptable score (for example, if a general-purpose, multi-paradigm, compiled programming language and a service for storing and accessing unstructured data have similar scores, the system can permutate across different combinations and present it to the user as an A/B test); (ii) whichever outcome generates more revenue can cause a feedback loop that would update the score and affect future recommendations; (iii) based on all permutations and simulated results, the ordering of the services on the website is determined; and (iv) the end result will be displayed on the webpage for a user.

Some embodiments of the present invention may include one, or more, of the following operations, features, characteristics and/or advantages: (i) auto-generation of a template for similar workflows can be extracted from the system; (ii) administrators will no longer need to manually define common templates that they think are most commonly used; (iii) the system is smart enough to know what common patterns are used for a given action; (iv) has the ability to display the list of recommended services dynamically; and (v) if a free and open-source content management system is provisioned, a list of other services you might be interested in can be provided.

Some embodiments of the present invention may include one, or more, of the following operations, features, characteristics and/or advantages: (i) uses AI (artificial intelligence) to try to typeahead what you are trying to build; (ii) dynamically groups potential services that will work with your current deployment and generate service templates for new users; (iii) by learning what users are doing, what services are best used together and dependent on each other, the user experience can be personalized by suggesting helpful services to go with your deployments; and (iv) what is currently deployed, and what other services you can leverage with your existing deployments, can be shown.

Some embodiments of the present invention may include one, or more, of the following operations, features, characteristics and/or advantages: (i) increases revenue through the recommendation of services; (ii) improves user experience and potentially saves costs by exposing services that are not as well-known or services that can be substituted; (iii) provides usefulness for an open cloud marketplace, a set of cloud computing services, and any other cloud service provider; (iv) can inspire innovation by suggesting trending services that can work with existing platforms; and (v) has the ability to explore new capabilities with deployed services using similar workflows.

Some embodiments of the present invention may include one, or more, of the following operations, features, characteristics and/or advantages: (i) by learning what users are doing, what services are best used together and dependent on each other, the user experience can be personalized by suggesting helpful services to go with your deployments; (ii) a personalized user experience for deploying services is proposed; and (iii) shows what is currently deployed, and what other services you can leverage with your existing deployments.

Some embodiments of the present invention may include one, or more, of the following operations, features, characteristics and/or advantages: (i) each service is associated to a version number; (ii) recommendations are suggested if it is determined that they work together; (iii) all information is drawn from existing deployments that are known to work; (iv) uses historical archives from the cloud provider, for example: (a) for a given known deployment, contains a cross-platform document-oriented database program, (b) an open-source, cross-platform runtime environment that executes program code outside a web browser, (c) other commercially available common services that others have deployed based on commercially available search engines, (d) a popular commercially available frontend, and (e) an open-source software library for building user interfaces; and (v) contains a brief description of the service and how it can impact business goals.

Some embodiments of the present invention may include one, or more, of the following operations, features, characteristics and/or advantages: (i) consists of finding correlations among services that are usually provisioned together; (ii) services can be classified into the same cluster or identification group; and (iii) based on millions of provisions, known algorithms can be confidently grouped, clustered, and classified to make recommendations for future provisioning.

Some embodiments of the present invention may include one, or more, of the following operations, features, characteristics and/or advantages: (i) the health and metrics of services can be monitored once they are provisioned and used; (ii) based on the incoming traffic, the effects of the incoming traffic on the hardware can clearly be seen; (iii) monitoring solutions currently exist that will auto provision new services to accommodate the spike in traffic; (iv) when a new user attempts to provision similar services, the system is smart enough to make recommendations on how much of that service to provision given the historical data; and (v) with additional technical details, may be able to use a neural network to get the predictive data.

In some embodiments of the present invention, data is split into two different types, usage data and deployment data. Example usage data includes service ID, product version, product license, and service tags. Example deployment data includes deployment ID, service ID, provision time, up-time, and latency. In practice, many more fields are likely to apply.

Some embodiments of the present invention may include one, or more, of the following operations, features, characteristics and/or advantages: (i) services are never provisioned alone, they are always paired with other services to create a usable tool; (ii) drawing correlations among services can be done a number of ways, one of which is via a clustering algorithm (for example, this would group services that are usually deployed together into similar clusters); and (iii) tags, for example, can be used to identify the type of service and anything else the cloud provider wants and can be represented as vectors and fed into a machine-learning software like a question-answering computer system capable of answering questions posed in natural language, or a free and open-source software library for dataflow and differentiable programming to add predictive capabilities.

Some embodiments of the present invention may include one, or more, of the following operations, features, characteristics and/or advantages: (i) anytime a consumer clicks on one of the recommendations, it kicks off a deployment and additional data is generated from this action; (ii) this data is eventually fed back into the recommendation engine to refine the model; (iii) additionally, the same recommendations can also be used to generate templates instead of relying on manual entry; (iv) templates can undergo the same process to get vetted where if a template is no good, the deployment would fail and the template is eliminated from the list; and (v) A/B testing can be performed on a small subset of users, and if we do not get any “clicks on it”, we know that it is not popular and we should decrease it's ranking.

Some embodiments of the present invention may include one, or more, of the following operations, features, characteristics and/or advantages: (i) has potential business value by facilitating new users on what they can do with all the services on cloud platforms; (ii) can educate current users on what services are available to work with their current deployments; and (iii) since it can be quite a daunting task to pick new services you do not know, embodiments of the system will help determine what can be used together as well as be able to dynamically chart what versions work with what tools.

In some embodiments of the present invention, services that can be used with a current deployment including: NodeJS v2.3+Elasticsearch v1+Angular versions 1, 2, 3, 4, and 5 are recorded in a database. For each combination of service products, a compatibility tag is applied. In some embodiments of the present invention, comments regarding history of combined deployments is recorded. (Note: the term(s) “NODEJS.” “ELASTICSEARCH,” and/or “ANGULAR” may be subject to trademark rights in various jurisdictions throughout the world and are used here only in reference to the products or services properly denominated by the marks to the extent that such trademark rights may exist.)

In some embodiments of the present invention, service stacks are established for various combinations of service products and corresponding versions. The offering of services via the service catalog may be represented by the various stacks of services.

Some embodiments of the present invention may include one, or more, of the following operations, features, characteristics and/or advantages: (i) once all of the bound services and their version number(s) are known, they can be grouped into a service stack and assigned a unique ID (identification) to the stack; (ii). each service and their version will be considered unique with a unique ID; and (iii) all of the service stacks can now be looked at by all users and the data reformatted so it can be fed into a clustering algorithm that takes into account the number of deployments of each service within each stack.

Some embodiments of the present invention may include one, or more, of the following operations, features, characteristics and/or advantages: (i) services bound together and identified by a cluster number are the results; (ii) whenever a user deploys a service in one of those cluster, there is the ability to recommend other services in the same cluster ranked by their version number and number deployed; and (iii) there is a number of ways the cloud provider can chose to rank the services, where the ranking criteria will determine which will get recommended first (for example, a ranking criteria is the frequency of the deployment or how much revenue that deployment generates).

Some embodiments of the present invention may include one, or more, of the following operations, features, characteristics and/or advantages: (i) the ranking criteria can also come from the user's perspective; (ii) account and user factors can be considered when weighting services to be grouped together; and (iii) these factors will be evaluated at a lower weight and include, but are not limited to: (a) account/account tier—enterprise vs free trial vs limited access, (b) company—industry, and (c) user traffic—pages visited and referrers.

Some embodiments of the present invention may include one, or more, of the following operations, features, characteristics and/or advantages: (i) the tool would weight an Enterprise Tier service lower for a user with a Lite or Freemium account, but may rate it higher for an Enterprise user; and (ii) weightings can be based on a user's company or industry (for example, rating blockchain higher for a known banking company account, or only recommending services with a given set of approved licenses).

Some embodiments of the present invention may include one, or more, of the following operations, features, characteristics and/or advantages: (i) by leveraging the user's traffic data, insight into organic searches can be gained that lead a user to a given service (for example, “Search: how to develop a chatbot” leads a user to clicking on AI (artificial intelligence) within a company's cloud service; and (ii) digesting page views for tutorials, documentation, and/or troubleshooting can loosely determine the users end goal and potential service interest.

Some embodiments of the present invention may include one, or more, of the following operations, features, characteristics and/or advantages: (i) provides personalization and/or recommendation; (ii) applies to service recommendations which are more complicated, have dependencies on each other, and can change over time depending on requirements; and (iii) takes into consideration any of user's current deployment.

Some embodiments of the present invention may include one, or more, of the following operations, features, characteristics and/or advantages: (i) improves the user experience for deploying services by leveraging a recommendation engine that uses existing and historical deployment and usage data; (ii) A/B testing and user input as feedback can be performed to refine the model; (iii) the end result is a page that shows the user what other services they can leverage with their deployments; and (iv) provides a dynamic way to generate templates without needing manual data entry.

Some embodiments of the present invention may include one, or more, of the following operations, features, characteristics and/or advantages: (i) uses deployment history to draw correlations between services and their versions to see what people normally deploy together in the cloud; (ii) uses commonly associated services to display the service catalog in a uniquely grouped way so the user finds needed services quickly; (iii) monitors services and generates a score for each service (based on various factors) in order to determine what services to do A/B testing on, thus determining which recommendations are working (feedback mechanism); (iv) dynamically builds templates for services based on various factors such as long term/short term cost, stability, scalability, multi-region, all open-source/certain licenses; and (v) provides examples of how to integrate new services to integrate into existing services (for example, suggesting other related services that can be taken advantage of).

A method according to an embodiment of the present invention for presenting services based on a history of usage data includes the following operations (not necessarily in the following order): (i) monitors usages of services offerings deployed in a dynamically provisioned cloud environment to identify products P [P1, P2, . . . , Pn] and services S [S1, S2, . . . , Sn] wherein Pi utilizes services Si and captures a history of deployment wherein the history of deployment includes metrics and a time ordered identification of products and services deployed detailed to include product versions (PV), service versions (SV), and system health; (ii) applies an artificial intelligence (AI) and machine learning (ML) to the captured history to form a recommendation model that scores usage generated templates for factors including dependencies, cost, account type, company/industry type, inter-service/product network traffic, stability, scalability, region, and open source licenses; (iii) utilizes the recommendation model to identify product and service groupings as offerings; (iv) generates a unique visual grouping of version compatible services and products based off of the usage generated template in a user interface (UI) catalog view; (v) provides a user interface (UI) allowing a user to identify and select product and service groupings to deploy and provide feedback to the recommendation model during a deployment of the identified products and services; (vi) responsive to the user utilizing the UI, adjusts the recommendation model based on the user provided feedback; (vii) wherein the metrics include provision time, up time, down time, fail-over rate, number of clicks, network latency, and user experience; and (viii) wherein the UI provides an option to select the product and services groupings based on a set of currently owned products and services by the user.

Some embodiments of the present invention may include one, or more, of the following operations, features, characteristics and/or advantages: (i) provides a unique grouping and visual layout based on the usage generated template; (ii) provides a novel approach to catalog generation and display; (iii) the metrics provide a score to be used for ranking purposes; and (iv) once a service has been deployed, continues to monitor the service for the metrics stated above, which gives a good idea of how the service performs over its lifetime and this performance directly contributes to the score used for ranking the offerings.

Some embodiments of the present invention may include one, or more, of the following operations, features, characteristics and/or advantages: (i) creates a grouping of services and products based on previous deployments; (ii) builds groupings by using things such as dependencies, cost, account type, company/industry type, inter-service/product network traffic, stability, scalability, region, open source licenses, versions, system health, etc.; (iii) determines what a new user is capable of deploying/ordering based on currently owned products and services; (iv) displays the available template groupings in the UI to the new users in question based on the predicted next most logical pairing of current services/products to new services and products; (v) provides system feedback based on data gathered by the system, not necessarily just user feedback; (vi) by a user accepting one of the new templates, deploys the service from the patented UI; and (vii) by running the service, the new development can use this new deployment, and all its possibly associated data, to enhance the template generating engine.

Some embodiments of the present invention may include one, or more, of the following operations, features, characteristics and/or advantages: (i) focused around services and applications deployed across a cloud environment to determine the best available templates of services to be deployed by a user, as sourced by all available determinable deployment combinations known (for example, how we differentiate would be: (a) if a user commonly deploys applications with service A, we aren't going to recommend to them anymore or any less of service A in our catalog customizations, and (b) we will instead see that the user has deployed service A and service B together and proceed to recommend Application J to them because we know, based on all deployed combinations of services and applications, that services A and B can deploy with Application J); (ii) takes services and applications and determine a recommended template of combined services to be presented to the UI of a user based on all available deployed sets of applications and services; (iii) is not concerned with an individual users preferences, but is more concerned with what services and applications are deployed in the current users cloud and how could that fit in with the available set of templates generated from successful deployments across all user's clouds; (iv) does not care if you commonly want to use a particular service, instead looks at all available templates from across the cloud offerings to determine recommended templates; and (v) is focused on the environment of available cloud offerings.

Some embodiments of the present invention may include one, or more, of the following operations, features, characteristics and/or advantages: (i) does not deal with customizing the users workflow but rather offering them unique bundles of products and services that will work together based on historical deployments; (ii); uses machine learning to identify products and services to recommend; (iii) does not deal with personalizing a “transaction workflow”; (iv) looks at the history of services deployed by all users in order to determine patterns and cluster related services together; (v) has the ability to learn and handle service versions for the user; (vi) uses machine learning on similar users historical usage data to determine unique groupings of products and services that will work with what you currently have in a service catalog (for example, factor in such things as dependencies, cost, account type, company/industry type, interservice/product network traffic, stability, scalability, region, and open source licenses from the cloud based environment to create personalized template offerings); and (vii) does not inject UI (user interface)/UX (user experience) help into the workflow based on the application context for the same end user.

Some embodiments of the present invention may include one, or more, of the following operations, features, characteristics and/or advantages: (i) does not involve any web searching or internet assistants; (ii) does not use “big data” to index the internet; (iii) builds a usage template to display a UI catalog view based on usage information across a given platform and other environment based information; and (iv) service versions and compatibility is taken into consideration and displayed to the user.

Some embodiments of the present invention may include one, or more, of the following operations, features, characteristics and/or advantages: (i) presents a recommendation system that handles versioning of different software as well as a graphical presentation of what that would look like, specifically, aimed at ranking cloud services for software as a service; (ii) focuses on gathering a large set of data points from the cloud based environment and combining them all into a series of N number of templates; (iii) templates are then provided to end users based on a number of factors that include, but are not limited to, the number of services they already have deployed in relation to one of the available N templates; and (iv) provides a service based template approach.

Some embodiments of the present invention may include one, or more, of the following operations, features, characteristics and/or advantages: (i) recommends cloud based services and applications that have determinable factors that can be coupled together to recommend a new solution, where it fits into known valid templates, based on data sourced from all available deployments; and (ii) provides a specific solution based around cloud services and applications.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

1. A computer-implemented method (CIM) comprising:
recording a historical data set including information indicative of: (i) identities of a plurality of cloud services, (ii) a plurality of cloud services accounts that respectively use at least some cloud services of the plurality of cloud services, (iii) usage of the plurality of services respectively by the plurality of cloud services accounts, and (iv) a plurality of performance metrics relating to the plurality of cloud services when used in various combinations in a cloud; and
identifying, by machine logic, a recommended cloud service group based on the historical data set, where the recommended cloud service group is constituted by a subset of the cloud services identified in the historical data set, such that the subset of cloud services in the recommended cloud services group: (i) are dependent upon each other, and (ii) perform favorably on at least one performance metric, of the plurality of performance metrics, when used together in combination.

2-18. (canceled)

19. The CIM of claim 1 further comprising:
recommending use of the recommended service group to a first cloud services user for use in a cloud.

20. The CIM of claim 1 wherein the plurality of performance metrics include at least one of the following: (i) provision time; (ii) uptime; (iii) downtime; (iv) fail-over rates; (v) fewest number of clicks; (vi) network latency; and (vii) user experience via feedback.

21. The CIM of claim 1 wherein the plurality of performance metrics include all of the following: (i) provision time; (ii) uptime; (iii) downtime; (iv) fail-over rates; (v) fewest number of clicks; (vi) network latency; and (vii) user experience via feedback.

22. A computer program product (CPP) comprising:
a set of storage device(s); and
computer code stored collectively in the set of storage device(s), with the computer code including data and instructions to cause a processor(s) set to perform at least the following operations:
recording a historical data set including information indicative of: (i) identities of a plurality of cloud services, (ii) a plurality of cloud services accounts that respectively use at least some cloud services of the plurality of cloud services, (iii) usage of the plurality of services respectively by the plurality of cloud services accounts, and (iv) a plurality of performance metrics relating to the plurality of cloud services when used in various combinations in a cloud, and
identifying, by machine logic, a recommended cloud service group based on the historical data set, where the recommended cloud service group is constituted by a subset of the cloud services identified in the historical data set, such that the subset of cloud services in the recommended cloud services group: (i) are dependent upon each other, and (ii) perform favorably on at least one performance metric, of the plurality of performance metrics, when used together in combination.

23. The CPP of claim 22 wherein the computer code further includes instructions for causing the processor(s) set to perform the following operation(s):
recommending use of the recommended service group to a first cloud services user for use in a cloud.

24. The CPP of claim 22 wherein the plurality of performance metrics include at least one of the following: (i) provision time; (ii) uptime; (iii) downtime; (iv) fail-over rates; (v) fewest number of clicks; (vi) network latency; and (vii) user experience via feedback.

25. The CPP of claim 22 wherein the plurality of performance metrics include all of the following: (i) provision time; (ii) uptime; (iii) downtime; (iv) fail-over rates; (v) fewest number of clicks; (vi) network latency; and (vii) user experience via feedback.

26. A computer system (CS) comprising:
a processor(s) set;
a set of storage device(s); and
computer code stored collectively in the set of storage device(s), with the computer code including data and instructions to cause the processor(s) set to perform at least the following operations:
recording a historical data set including information indicative of: (i) identities of a plurality of cloud services, (ii) a plurality of cloud services accounts that respectively use at least some cloud services of the plurality of cloud services, (iii) usage of the plurality of services respectively by the plurality of cloud services accounts, and (iv) a plurality of performance metrics relating to the plurality of cloud services when used in various combinations in a cloud, and
identifying, by machine logic, a recommended cloud service group based on the historical data set, where the recommended cloud service group is constituted by a subset of the cloud services identified in the historical data set, such that the subset of cloud services in the recommended cloud services group: (i) are dependent upon each other, and (ii) perform favorably on at least one performance metric, of the plurality of performance metrics, when used together in combination.

27. The CS of claim 26 wherein the computer code further includes instructions for causing the processor(s) set to perform the following operation(s):
recommending use of the recommended service group to a first cloud services user for use in a cloud.

28. The CS of claim 26 wherein the plurality of performance metrics include at least one of the following: (i) provision time; (ii) uptime; (iii) downtime; (iv) fail-over rates; (v) fewest number of clicks; (vi) network latency; and (vii) user experience via feedback.

29. The CS of claim 26 wherein the plurality of performance metrics include all of the following: (i) provision time; (ii) uptime; (iii) downtime; (iv) fail-over rates; (v) fewest number of clicks; (vi) network latency; and (vii) user experience via feedback.
